(19) United States
(12) Patent Application Publication
(10) Pub. No.: US 2026/0052198 A1
(43) Pub. Date: Feb. 19, 2026

(54) DYNAMIC PACKET COMPRESSION FOR TRANSMITTING NUMERICAL DATA

(71) Applicant: NVIDIA Corp., Santa Clara, CA (US)

(72) Inventors: Benjamin Klenk, San Jose, CA (US); Larry Robert Dennison, Mendon, MA (US)

(73) Assignee: NVIDIA Corp., Santa Clara, CA (US)

(21) Appl. No.: 18/805,300

(22) Filed: Aug. 14, 2024

(51) Int. Cl. H04L 69/04; H04L 1/00; H04L 69/22

(52) U.S. Cl. CPC H04L 69/04; H04L 1/0084; H04L 69/22

(57) ABSTRACT

Data networks that include an ingress port and multiple per-vector scaled quantization encoders are configured to respond to receiving a vector of values at the ingress port by operating the per-vector scaled quantization encoders on the vector to generate reduced vectors, score each of the reduced vectors according to a precision loss, and select one of the reduced vectors to inject into the network based on the score.

### GOVERNMENT SUPPORT

This invention was made with US Government support under contract H98230-20-3-0001 (TetheredTiger aka Meteorite) awarded by the Department of Defense. The US Government has certain rights in this invention.

### BACKGROUND

Training and inference of artificial intelligence workloads involves communication between processors over channels that are lower bandwidth than the processor's memory system, creating a system bottleneck. During artificial intelligence (AI) training, activations, gradients, and weight gradients may be communicated over channels (e.g., serial lines and/or busses) between processors. Typically, during inference, only activations may be communicated. Increasing the inherent transfer rates of channels may be difficult. In some cases the communicated data may be compressed to increase the effective bandwidth of a channel.

Traditional compression algorithms require significant computing resources and may be unsuitably slow for networks with high link parallelism and bandwidth. One type of compression mechanism is quantization, whereby the precision of numeric values is reduced to fit into narrower (fewer bits per value) data types. For example, a 16 bit floating point value may be reduced to a 4 bit integer values plus a scaling factor, with loss of some precision.

Tensor quantization provides technological benefits to AI training and inference including (1) reduced memory consumption, (2) faster computation, and (3) power savings. Exploiting sparsity is another mechanism to reduce tensor sizes, and obtains similar benefits. Sparsity occurs when there are many zeros in the data (natural sparsity), or when data values are transformed to zero (induced sparsity) based on some threshold condition(s).

A challenge with implementing quantization and/or sparsity mechanisms is to obtain the technological benefits without negatively impacting the convergence of AI training algorithms due to loss of too much data precision.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B depict a system and process for transferring data between two processors over a data network.

FIG. 2A depicts logic for compressing vectors carried by packets at the ingress to a network in one embodiment.

FIG. 2B depicts logic to progressively apply compression and/or pruning to a packet vector.

FIG. 3 depicts formats for E4M3 and E5M2 8-bit floating point (FP8) encodings.

FIG. 4 depicts formats for various 4-bit floating point (FP8) encodings.

FIG. 5 depicts various signed and unsigned FP4 data formats.

FIG. 6A depicts an exemplary vector reduction from applying a 2:4 sparsity mechanism.

FIG. 6B depicts an exemplary vector reduction from applying an FP16→FP4 per-vector scaled quantization mechanism.

FIG. 7 depicts a neural network processor implemented on a single chip in accordance with one embodiment.

FIG. 8 depicts a local processing element 800 in accordance with one embodiment.

FIG. 9 depicts a parallel processing unit 902 in accordance with one embodiment.

FIG. 10 depicts a general processing cluster 1000 in accordance with one embodiment.

FIG. 11 depicts a memory partition unit 1100 in accordance with one embodiment.

FIG. 12 depicts a streaming multiprocessor 1200 in accordance with one embodiment.

FIG. 13 depicts a processing system 1300 in accordance with one embodiment.

FIG. 14 depicts an exemplary processing system 1400 in accordance with another embodiment.

FIG. 15 depicts a graphics processing pipeline 1500 in accordance with one embodiment.

### DETAILED DESCRIPTION

Disclosed herein are mechanisms utilizing quantization and/or sparsity to compress individual network packets at source endpoints from which the packets are injected into a data network. These mechanisms may be utilized to exploit the inherent resiliency of deep learning training or inference workloads to improve the data transport and energy efficiency of computer networks utilized with those workloads. Although described in the context of artificial intelligence applications, the disclosed mechanisms apply generally to the processing and communication of numerical data in computing systems.

Quantization during training or inference enables efficient acceleration of deep learning workloads by reducing model memory footprint and exploiting low-cost integer or smaller floating point math hardware units. Quantization maps floating-point weights and activations in a trained model to low bit-width values using scale factors. Excessive quantization, reducing precision too aggressively, results in degradation of the accuracy of the model. When scale factors are shared at a coarse granularity across many dimensions of each tensor, effective precision of individual elements within the tensor are limited.

Packets that are compressed upon ingress to the data network may be decompressed upon exiting the network at destination endpoints. Utilizing quantization and sparsity reduces traffic volume in the network and limits network volume to tensors that are communicated (versus those used locally in a particular processor). A master copy of the compressed data may be retained in memory to mitigate information loss using known precision recovery techniques. The disclosed mechanisms are transparent to the network and may be activated or deactivated as needed. Quantization and/or sparsity reductions may be applied dynamically on a per-packet basis.

A mechanisms known as per-vector scaled quantization quantizes individual vectors that are smaller components of a full tensor. Per-vector scaled quantization mechanisms may be applied in the network by processing individual packets as vectors.

The disclosed mechanisms reduce memory footprint, accelerate math operations, save power, and improve network bandwidth. A processor transmitting the data over the network may maintain a master copy of quantized packet data at full precision. Packet pruning may be utilized to further exploit sparsity and improve compression ratios. A quality metric may be computed and utilized to determine the type of compression(s) to apply to particular packets, if any. An entire tensor need not be subjected to compression; instead, compression on the tensor may be applied piecemeal using mechanisms that result in less impact on convergence.

To reduce quantization-related accuracy loss, per-vector scale factors (VS-Quant) may be applied to subset (e.g., 16-64 element) vectors within a single dimension of a tensor. To achieve an efficient hardware implementation, the per-vector scale factors may be implemented with low bit width integers when calibrated using a two-level quantization scheme.

Exponent biasing may be utilized in the data encodings. Exponent bias controls the representable range of real values (e.g., by shifting the range along the real number line). Exponent biasing also enables the exponent to be represented as an unsigned value more amenable to comparison. A biased exponent may be converted into a signed range for addition or subtraction by subtracting the bias. One common calculation of an exponent bias is 26-1, where E is the number of exponent bits. The fields of the exponent value may be arranged such that the sign bit takes the most significant bit position, the biased exponent takes the middle position, then the significand occupies the least significant bits. This format enables high speed comparisons between floating-point numbers using fixed-point hardware. The E4M3 and E5M2 encodings (8-bit floating point formats described in more detail below) may utilize exponent biases of 7 and 15, respectively.

The disclosed mechanisms may be implemented in communication mechanisms other than networks. For example, the disclosed mechanisms may be implemented in a processor's cache memory or direct memory access (DMA) controller to dynamically compress data that is written to or read from the memory system. Additional metadata may be associated with data to identify the format in which it is stored. When reading data from memory the reading component may decompress the data before it is written to registers and used as operands in math hardware units.

When data is sent over the network it is packetized and composed of a header and the data payload. Exemplary payload sizes range from 128 bytes to multiple kilobytes.

Some networks, such as NVLink described further below, roughly distinguish between read and write operations that operate on globally shared addresses. When a write request arrives at an ingress port, a header is created, and the packet is injected into the network carrying both the header and the payload from the original write request. At this point the disclosed mechanisms may operate to quantize the data or prune the data (increase its sparsity). An address region of a device or chip may be configured as compressible. In response to detecting operations to the configured address region, the port management logic may apply compression only if certain conditions are met.

Compression may be initiated by deriving a metric on the data that determines whether to apply compression or not when the data is communicated. The same or another metric may determine which type(s) of compression to apply.

In one embodiment of a per-vector scaled quantization mechanism, a bit-width after quantization is configured. This setting may be dynamic in some quantization schemes, meaning it may vary according to the application precision requirements, the network load, power constraints, or other factors that vary across computational loads.

By way of example, consider an incoming 124 byte payload formatted as FP16 values. The 124 bytes may be treated as a vector, and the system may quantize the vector values into both of a 4-bit format and an 8-bit format, each with an associated FP16 scaling factor.

A root mean square error (RMSE) or other metric may be generated for the compressed packet and the original packet. The metric may determine the residuals of the compression, which is a difference between the uncompressed precision and the precision after compression. An average of these differences (squared) may be taken, and square root of this average determined to generate the evaluation metric.

On condition that the evaluation metric for neither of the 4-bit per-vector scaled quantization and the 8-bit per-vector scaled quantization satisfies a configured threshold (of acceptable precision loss), the packet injected into the network without compression. On condition that both evaluation metrics satisfy the threshold, the lower bit-width per-vector scaled quantization (4-bit) is applied to the packet before it is injected into the network. On condition that neither of these circumstances apply, the higher bit-width per-vector scaled quantization (8-bit) is applied to the packet before it is injected into the network, or the original uncompressed data may be sent.

By way of another example, consider an incoming packet comprising a vector of 64 FP16 values. The system may be configured to apply a number of pruning policies to the vector and to select the one that meets implementation constraints on compression and precision. An example of a pruning policy is 2:16, meaning that the system keeps only two values out of every consecutive 16 values (maintains the value and its position in the vector), and ‘zeros’ the others (e.g., removes them from the packet. Generally, sparsity mechanisms of this type may be characterized by n:m, where m is a group size and n<m is a number of values to retain or drop from the group of m. The system may be configured to apply to incoming packets multiple pruning/sparsity policies such as 1:16, 2:16, 4:16, etc., and to select the one (or none) that meets compression and precision constraints.

A system may learn over time the most efficient types of sparsity and/or quantization to apply. For example in a particular system there may be N possible mechanisms enabled for compressing a packet. When the system is initially put into operation it may evaluate all N mechanisms and choose the most efficient one(s). Over time the system may determine that only M<N of the compression mechanisms are applied, and may confine evaluation to those M mechanisms. The system may on occasion evaluate all N mechanisms again to confirm the subset M remain the most efficient choices.

The packet header may be configured with settings indicating the type of compression(s) applied (if any). In one embodiment, both of 4-bit and 8-bit quantization are applied in parallel to packets received at network ports, and the respective metrics of compression quality are determined, also in parallel. Sparsity enhancement may also be applied pre- or post-quantization.

In one embodiment, at the receiver, the packet headers may be examined and de-quantization and/or vector expansion from sparse formats is applied to the vectors before forwarding the packets to the processor's memory system. This makes the compression mechanisms transparent to the higher-level application (e.g., AI training or inference applications).

In another embodiment, the vectors may be maintained in compressed form until an operation is initiated to load the vectors from system memory (e.g., DRAM or cache memory) to the processor's register file. At load time, the processor or controlling application may configure (e.g., through a setting on the load instruction or through a separate instruction) whether or not to dequantize the vectors at the memory, or to continue processing using the quantized data. In this implementation, the dynamic quantization/pruning behavior among vectors within a tensor may be disabled, so that a consistent quantized format and/or pruning mechanism that is applied within a given tensor. This ensures that the values within a tensor maintain a consistent format as perceived by the controlling application.

The disclosed mechanisms may be implemented for example in network ports, in Infiniband networks, in Ethernet network interfaces, or in switches to enable switch-to-switch compression of numerical data. This improves effective bandwidth to one or more of increase network performance, reduce hardware infrastructure costs, and reduce power consumption.

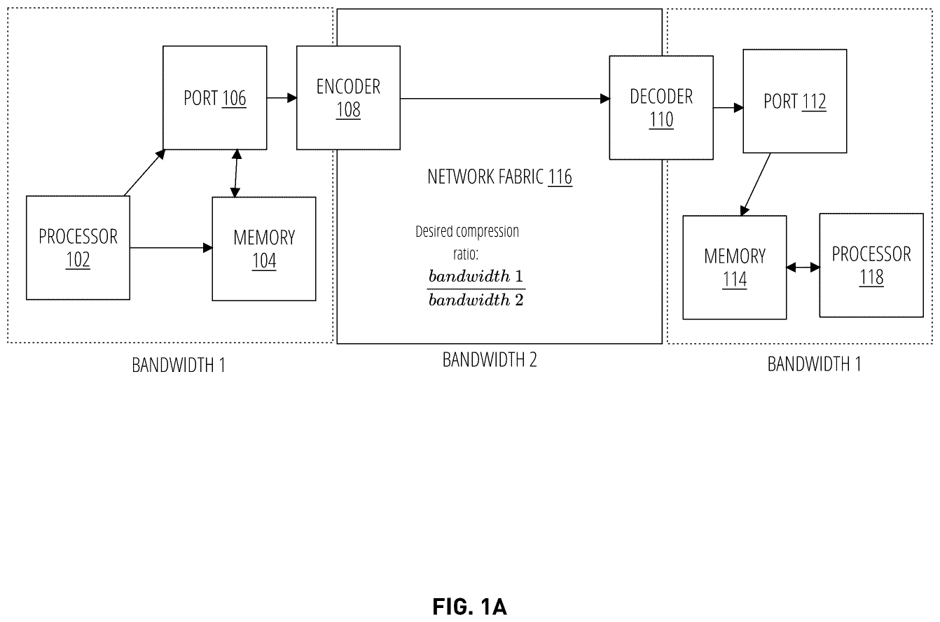

FIG. 1A and FIG. 1B depict a system and process for transferring a vector of data (e.g., in a packet) between two processors over a data network. A first processor 102 writes the data vector to a first memory 104 (block 120). The first processor 102 instructs a source network port 106 to transfer the data (from the address in the memory 104 at which the data was written) over the network fabric 116 (or more generally, any data communication link) to a second processor 118 (block 122). The port 106 reads the data from the memory 104 (block 124) and the data is compressed (block 126) with one or more encoders 108 and communicated over the network fabric 116 (block 128) to a port 112, where the decoder 110 expands/decompressed the data (block 130). Expanding/decompressing the vector may generally involve expanding the number of data bits used to represent each value of the vector (when quantization compression is applied), and/or adding zero-valued elements back into the vector (when induced sparsity is applied).

The expanded/decompressed data is written to the second memory 114 (block 132). The second processor 118 reads the expanded/decompressed data from the second memory 114 (block 134) in the course of processing a workload, e.g., a training or inference workload.

As noted above, in an alternative implementation the data is not decoded at the second port, and is written to the destination memory 114 in compressed form.

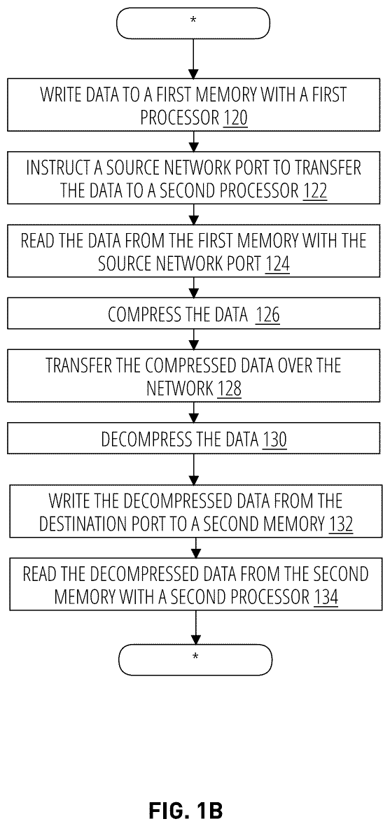

FIG. 2A depicts logic for compressing vectors carried by packets at the ingress to a network in one embodiment. The logic comprises a variety of encoders 202, 204 . . . (lossy compression) and a variety of pruners 206, 208 (sparsity/reduction generators). In some systems, optional compositing logic may be implemented to apply and score combinations of encoding and pruning to the vectors. Although straightforward to implement in light of the depicted mechanisms, the cost in size, area, and complexity of evaluating such combinations may be prohibitive in some systems.

A compression mode selector 210 determines which from among the various modalities provides, for the contents a given packet, a best combination of compression and precision (or no compression/reduction) according to configured constraints thereon (e.g., based on a RMSE score on the reduced vectors determined by scoring logic 212). A metadata setting (M) is inserted into each packet by the compression mode selector 210 to indicate to destination endpoints of the packet which modality was applied to each packet at ingress to the network, as well as per-vector quantization parameters such as scale factors.

To improve bandwidth the different encoding modalities and the different pruning modalities may be applied in parallel (e.g., by parallel hardware circuits or software logic executing with true parallelism in multiple execution cores) on the initial packet contents.

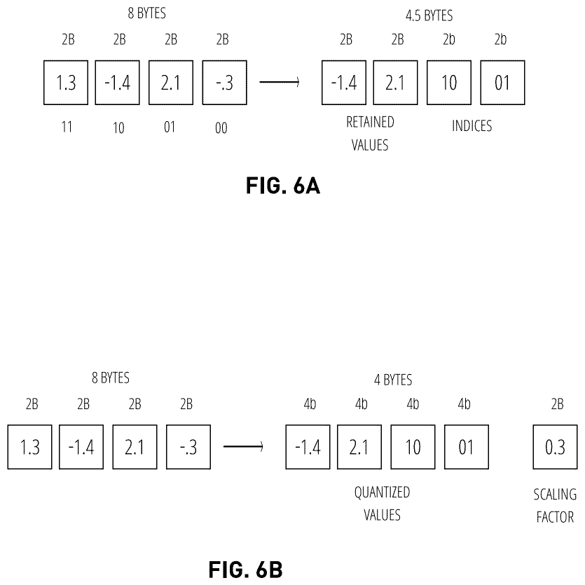

The structure of any sparsity may be configured in a variety of ways. For example, the vector indices of retained values may be conveyed along with the values in the packet, wherein the indices are local to a sparse grouping. This approach is depicted for a 2:4 sparsity mechanism in FIG. 6A, where each index is local to a 2:4 group. Another manner of structuring the sparsity is to run-length encode sequential runs of zero-values in the vector. This may be useful for sparsity mechanisms that introduce long runs of zero values.

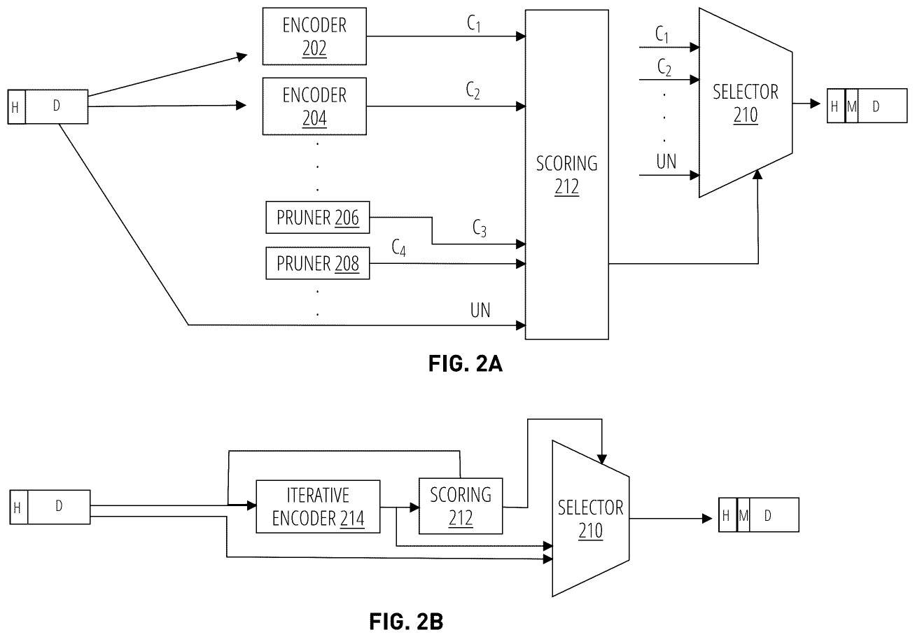

FIG. 3 depicts a specification of E4M3 and E5M2 8-bit floating point (FP8) encodings in S.E.M notation, where S is the sign bit, E is the exponent field (either 4 or 5 bits containing biased exponent), and M is either a 3- or a 2-bit mantissa. Values with a two (2) in the subscript are binary, otherwise they are decimal. In one embodiment the encoders 202, 204 implement one or both of these compression schemes on 16-bit or 32-bit floating point values in the packet vectors. Formats comprising 4-bit exponents and 3-bit mantissas provide a substantially reduced exponent range compared with high-precision floating point formats. The constrained exponent range enables direct conversion to integer (INT) data formats, which are efficient to process in hardware arithmetic logic units.

In one implementation one of the encoders may compress 16-bit or 32-bit values in the packet vector into an 8-bit floating point format (FP8) that is one of E4M3 and E5M2, where E is a number of exponent (E) bits and M is a number of mantissa bits. “Mantissa” refers to the IEEE 754 specification's trailing significand field (i.e. bits not including the implied leading 1 bit for normal floating point numbers). The E4M3 encoding may be particularly applicable to compression of packets comprising vectors that make up weight and activation tensors in deep learning applications. The E5M2 encoding may be particularly applicable for compressing packets comprising vectors for gradient tensors in these applications. Some deep learning applications may train with just the E4M3 or the E5M2 data types, whereas others may benefit from training with both types.

Some implementations may utilize less than all of the components depicted in FIG. 2A. For example not all implementations may generate composite modalities for scoring, or may utilize multiple encoding modalities and a single or no pruning modalities, or vice versa.

Another embodiment is depicted in FIG. 2B. In this embodiment compression and/or pruning is progressively applied to the packet vector by an iterative encoder 214. Iteration on the packet may continue until one or more of the following conditions is satisfied: (1) a configured amount of size reduction is achieved in the packet contents, (2) the reduction score fails to satisfy a configured constraint on precision loss, or (3) a configured time interval to complete the reduction is violated.

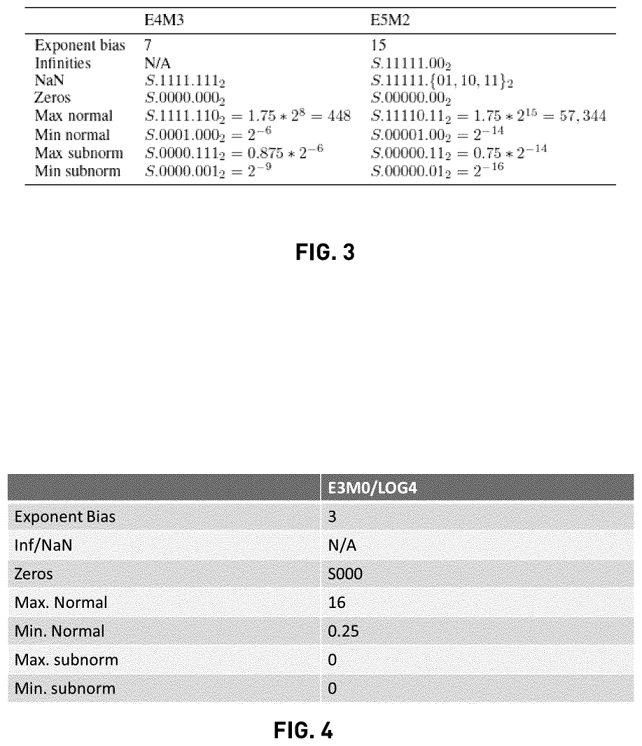

In some embodiments one or more of the encoders implements compression of 16-bit or 32-bit values in the packet vectors to 4-bit floating point formats (FP4). One such FP4 format that may be implemented encodes the vector values in E2M1 format with a per-vector scaling factor formatted in an unsigned E3M1 format. In addition to bandwidth and energy savings in the data network, utilization of quantized 4-bit precision may enable a significant reduction in the area and energy consumption of the vector multiply-accumulate unit logic utilized to process the vectors in deep learning workloads. Other FP4 and quantized FP4 formats may also be utilized (e.g., E1M2, E0M3, E3M0 vectors with E4M0, E2M2, E1M3, E0M4 per-vector scale factors—see FIG. 4) depending on the constraints of the implementation. In some implementations the bit width of per-vector scale factors may be increased beyond four bits (e.g., to eight bits) with some corresponding increase in logic size and/or complexity.

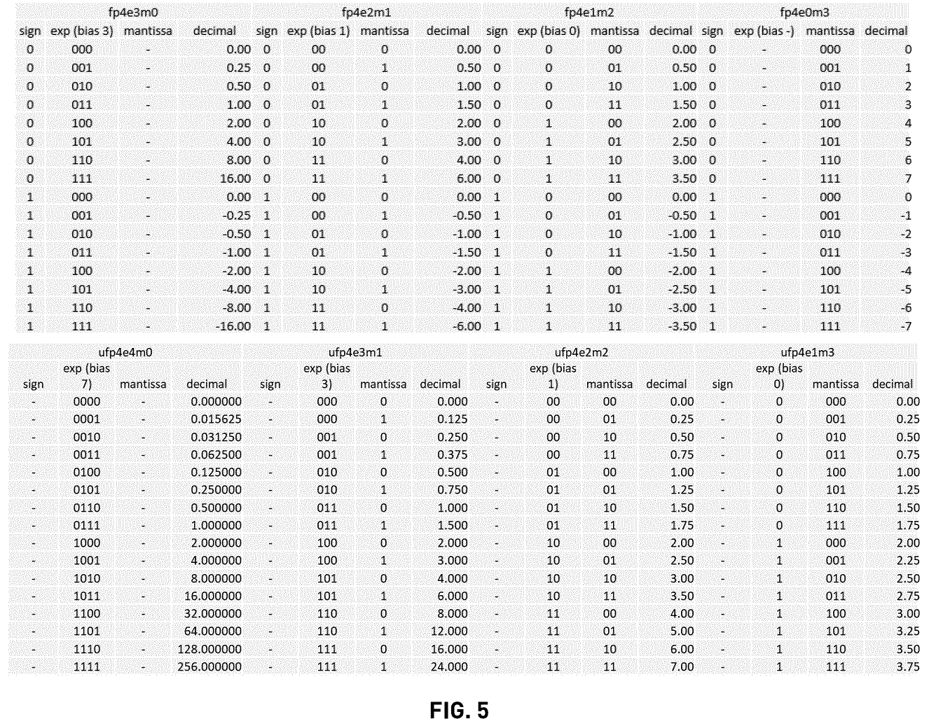

In some embodiments one or more of the encoders may compress 16-bit or 32-bit floating point vector values into FP4 formats (E2M1, E1M2, E0M3) with an FP4 or FP8 formatted scale factor applied to all elements in the vector. One such implementation quantizes the vector elements each into a fixed-point exponent-only format (E3.0, E2.1, E1.2) with an exponent bias scale factor applied to each element in the vector. In one such implementation a base of the data format is determined as base=2^{1/base_factor} and the exponent representation is Eq·r where q is the number of quotient bits and r is the number of remainder bits. The exponent may be represented as a fixed-point value (e.g., E3.0, E2.1, E1.2) format, for example. FIG. 5 depicts various signed and unsigned FP4 data formats. In these implementations, the value and precision of the operands is carried entirely in the exponent values (excepting the sign bit).

FIG. 6A depicts an exemplary vector reduction from applying a 2:4 sparsity mechanism. The eight original bytes of four FP16-formatted values in the vector is reduced to six bytes comprising two FP16 values and their associated indices in the group by pruning the two values with the lowest absolute magnitudes.

FIG. 6B depicts an exemplary vector reduction from applying an FP16→FP4 per-vector scaled quantization mechanism. The eight original bytes of four FP16-formatted values in the vector is reduced to six bytes comprising four FP4 values and their associated scale factor.

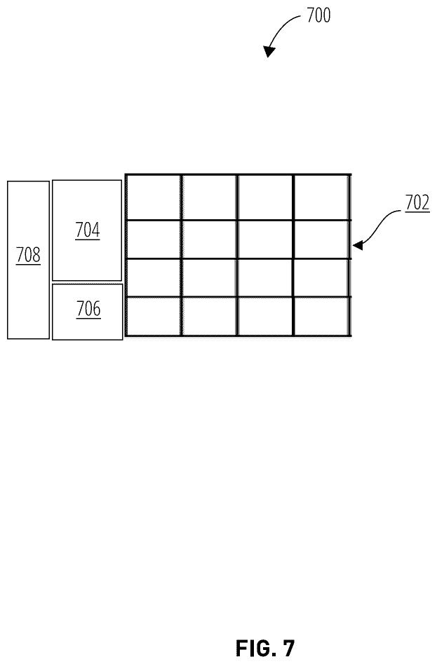

FIG. 7 depicts a neural network processor 700 embodied on a single chip. The neural network processor 700 may utilize a plurality of processing elements 702. The neural network processor 700 also comprises a global buffer 704 and controller 706, which for example may be a RISC-V processor. The processing elements 702 and global buffer 704 communicate via the network-on-a-chip switch/router or other interconnect technology (see the GPU implementations, described further below). The router may be implemented centrally or in distributed fashion as routers on each of the processing elements 702. The processing elements 702 utilize the router/interconnect to communicate with processing elements on the same package, or in some embodiments across packages via a network-on-a-package router 708. However it is implemented, the router/switch may be configured with a packet reduction mechanism in accordance with the embodiments disclosed herein.

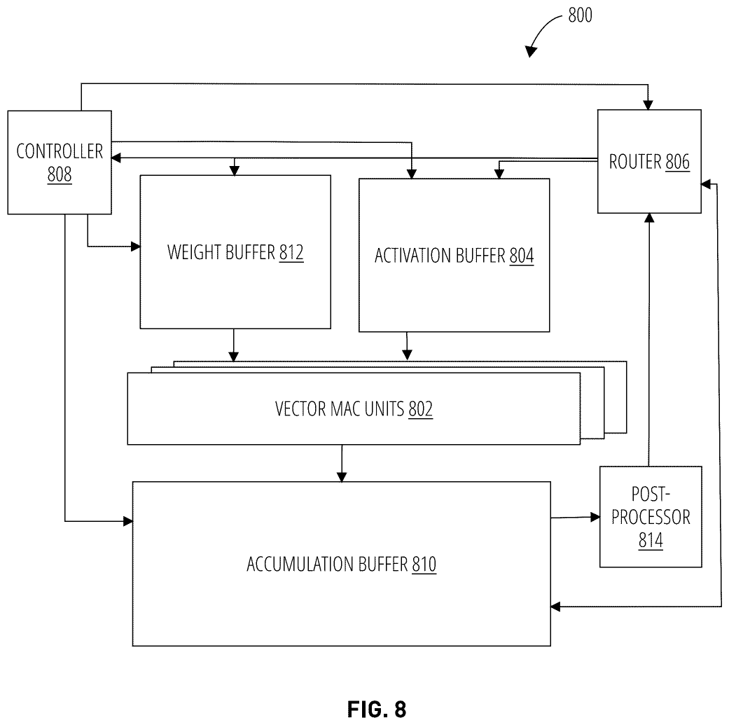

FIG. 8 depicts, and a high level, an exemplary processing element 800 that may implement one or more of the processing elements 702. The processing element 800 includes a plurality of vector multiply-accumulate units 802, a weight buffer 604, an activation buffer 804, a router 806, a controller 808, an accumulation memory buffer 810, and a post-processor 612. The activation buffer 804 may, in one embodiment, be implemented as a dual-ported SRAM to receive activation values from the global buffer 704 or from other local or global processing elements, via the router 806 or other interconnect. The router 608 may be a component of a distributed network-on-a-chip router that in one embodiment comprises a serializer/de-serializer, packetizer, arbitrator, Advanced extensible Interface, and other components known in the art.

The weight buffer 812 may, in one embodiment, be implemented as a single-ported SRAM storing weigh values. The weight values used by the vector multiply-accumulate units 802 may be “weight-stationary”, meaning they are not updated each clock cycle, but instead are updated only after the output activation values are computed for a particular layer of the deep neural network.

The accumulation memory buffer 810 may comprise one or more SRAM devices to store the output activations computed by the vector multiply-accumulate units 802. The router 806 communicates these output activations and control signals from the processing element 800 to other processing elements. “Output activation” refers to an activation output by a neuron in a neural network. An output activation is typically computed based on the input activations to the neuron and the weights applied to the input activations. “Input activation” refers to an activation received by a neuron in a neural network.

The processing element 800 may perform all operations of convolutional and fully-connected layers of a DNN efficiently, including multiply-accumulate, truncation, scaling, bias addition, ReLU, and pooling (these last five in the post-processor 814). The vector multiply-accumulate units 802 may operate on the same inputs using different filters. In one embodiment, each of the vector multiply-accumulate units 802 performs an eight-input-channel dot product and accumulates the result into the accumulation memory buffer 810 on each clock cycle. The weights stored in the weight buffer 812 are unchanged until the entire computation of output activations completes. Each processing element 800 reads the input activations in the activation buffer 804, performs the multiply-accumulate operations, and writes output activations to the accumulation memory buffer 810 on every clock cycle. The frequency at which the weight buffer 812 is accessed depends on the input activation matrix dimensions and the number of filters utilized.

The vector multiply-accumulate units 802 of each processing element 800 computes a portion of a wide dot-product-accumulate as a partial result and forwards the partial result to neighboring processing elements. “Dot-product-accumulate” refers to the computation of a dot product. A dot product is the sum of the products of the corresponding entries of the two sequences (vectors) of numbers. Dot products are efficiently computed using vector multiply-accumulate units. “Multiply-accumulate unit” refers to a data processing circuit that carries out multiply-accumulate operations, which involve computing the product of two numbers and adding that product to an accumulator. Multiply-accumulate units may be referred to herein by their acronym, MAC or MAC unit. A multiply-accumulate unit carries out computations of the form a<-a+(b*c). A vector multiply-accumulate unit computes the product of two vectors using an array of multipliers, then performs a reduction operation by adding all the outputs of multipliers to produce a partial sum, which is then added to an accumulator. The partial results are transformed into a final result by the post-processor 814 and communicated to the global buffer 704. The global buffer 704 operates as a staging area for the final multiply-accumulate results between layers of the deep neural network.

The accumulation memory buffer 810 receives outputs from the vector multiply-accumulate units 802. The central controller 706 distributes the weight values and activation values among the processing elements and utilizes the global memory buffer as a second-level buffer for the activation values. When processing images, the controller 706 configures processing by layers of the deep neural network spatially across the processing elements by input/output channel dimensions and temporally by image height/width.

The global buffer 704 stores both input activations and output activations from the processing elements 702 for distribution by the aforementioned transceivers to the processing elements via multicast. “Multicast” refers to a group communication mechanism whereby transmission of data is addressed to a group of destination devices (e.g., processing elements) simultaneously. Multicast can implement one-to-many or many-to-many distribution. Each of the processing elements 702 includes a router 806 to communicate, in one embodiment, 64 bits of data in, and 64 bits of data out, per clock cycle. This enables accumulation of partial sums for wide dot products that have their computation spatially tiled across the processing elements 702.

The mechanisms disclosed herein may be implemented by computing devices utilizing one or more graphic processing unit (GPU) and/or general purpose data processor (e.g., a ‘central processing unit or CPU). Exemplary architectures will now be described that may be configured to carry out the techniques disclosed herein on such devices. For example, in the computing architectures described below, embodiments of the disclosed mechanisms may be implemented by one or more of NVLink 904, the interconnect 906, the crossbar 908, the memory interface 1102, the interconnect network 1202, the switch 1302, and the communications bus 1402.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

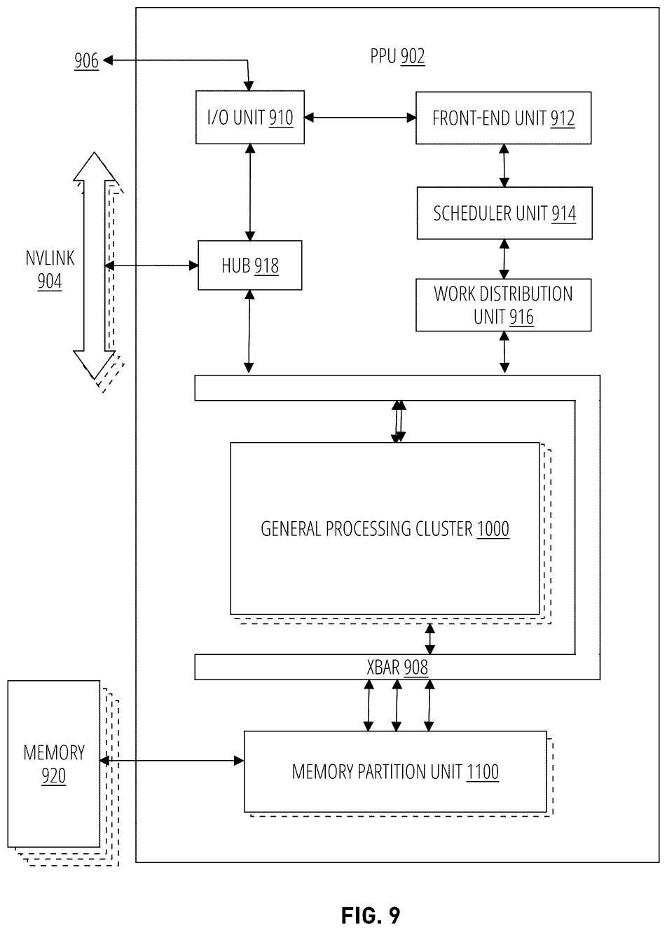

FIG. 9 depicts a parallel processing unit 902, in accordance with an embodiment. In an embodiment, the parallel processing unit 902 is a multi-threaded processor that is implemented on one or more integrated circuit devices. The parallel processing unit 902 is a latency hiding architecture designed to process many threads in parallel. A thread (e.g., a thread of execution) is an instantiation of a set of instructions configured to be executed by the parallel processing unit 902. In an embodiment, the parallel processing unit 902 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 902 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 902 modules may be configured to accelerate thousands of High Performance Computing (HPC), data center, and machine learning applications. The parallel processing unit 902 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 9, the parallel processing unit 902 includes an I/O unit 910, a front-end unit 912, a scheduler unit 914, a work distribution unit 916, a hub 918, a crossbar 908, one or more general processing cluster 1000 modules, and one or more memory partition unit 1100 modules. The parallel processing unit 902 may be connected to a host processor or other parallel processing unit 902 modules via one or more high-speed NVLink 904 interconnects. The parallel processing unit 902 may be connected to a host processor or other peripheral devices via an interconnect 906. The parallel processing unit 902 may also be connected to a local memory comprising a number of memory 920 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 920 may comprise logic to configure the parallel processing unit 902 to carry out aspects of the techniques disclosed herein.

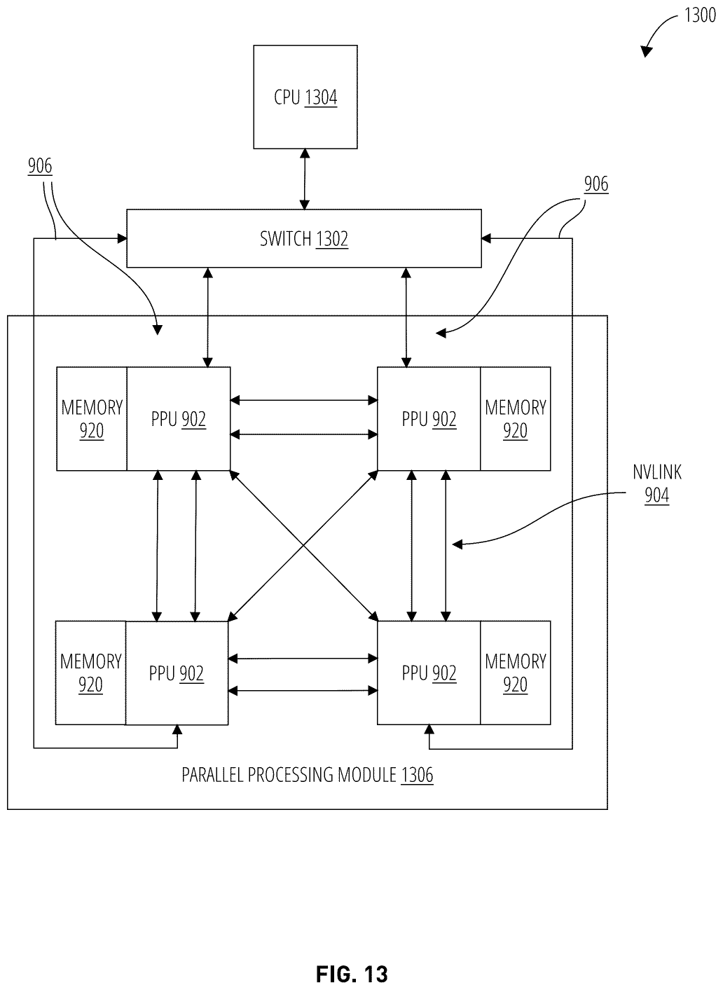

The NVLink 904 interconnect enables systems to scale and include one or more parallel processing unit 902 modules combined with one or more CPUs, supports cache coherence between the parallel processing unit 902 modules and CPUs, and CPU mastering. Data and/or commands may be transmitted by the NVLink 904 through the hub 918 to/from other units of the parallel processing unit 902 such as one or more copy engines, a video encoder, a video decoder, a power management unit, etc. (not explicitly shown). The NVLink 904 is described in more detail in conjunction with FIG. 13.

The I/O unit 910 is configured to transmit and receive communications (e.g., commands, data, etc.) from a host processor (not shown) over the interconnect 906. The I/O unit 910 may communicate with the host processor directly via the interconnect 906 or through one or more intermediate devices such as a memory bridge. In an embodiment, the I/O unit 910 may communicate with one or more other processors, such as one or more parallel processing unit 902 modules via the interconnect 906. In an embodiment, the I/O unit 910 implements a Peripheral Component Interconnect Express (PCIe) interface for communications over a PCIe bus and the interconnect 906 is a PCIe bus. In alternative embodiments, the I/O unit 910 may implement other types of well-known interfaces for communicating with external devices.

The I/O unit 910 decodes packets received via the interconnect 906. In an embodiment, the packets represent commands configured to cause the parallel processing unit 902 to perform various operations. The I/O unit 910 transmits the decoded commands to various other units of the parallel processing unit 902 as the commands may specify. For example, some commands may be transmitted to the front-end unit 912. Other commands may be transmitted to the hub 918 or other units of the parallel processing unit 902 such as one or more copy engines, a video encoder, a video decoder, a power management unit, etc. (not explicitly shown). In other words, the I/O unit 910 is configured to route communications between and among the various logical units of the parallel processing unit 902.

In an embodiment, a program executed by the host processor encodes a command stream in a buffer that provides workloads to the parallel processing unit 902 for processing. A workload may comprise several instructions and data to be processed by those instructions. The buffer is a region in a memory that is accessible (e.g., read/write) by both the host processor and the parallel processing unit 902. For example, the I/O unit 910 may be configured to access the buffer in a system memory connected to the interconnect 906 via memory requests transmitted over the interconnect 906. In an embodiment, the host processor writes the command stream to the buffer and then transmits a pointer to the start of the command stream to the parallel processing unit 902. The front-end unit 912 receives pointers to one or more command streams. The front-end unit 912 manages the one or more streams, reading commands from the streams and forwarding commands to the various units of the parallel processing unit 902.

The front-end unit 912 is coupled to a scheduler unit 914 that configures the various general processing cluster 1000 modules to process tasks defined by the one or more streams. The scheduler unit 914 is configured to track state information related to the various tasks managed by the scheduler unit 914. The state may indicate which general processing cluster 1000 a task is assigned to, whether the task is active or inactive, a priority level associated with the task, and so forth. The scheduler unit 914 manages the execution of a plurality of tasks on the one or more general processing cluster 1000 modules.

The scheduler unit 914 is coupled to a work distribution unit 916 that is configured to dispatch tasks for execution on the general processing cluster 1000 modules. The work distribution unit 916 may track a number of scheduled tasks received from the scheduler unit 914. In an embodiment, the work distribution unit 916 manages a pending task pool and an active task pool for each of the general processing cluster 1000 modules. The pending task pool may comprise a number of slots (e.g., 32 slots) that contain tasks assigned to be processed by a particular general processing cluster 1000. The active task pool may comprise a number of slots (e.g., 4 slots) for tasks that are actively being processed by the general processing cluster 1000 modules. As a general processing cluster 1000 finishes the execution of a task, that task is evicted from the active task pool for the general processing cluster 1000 and one of the other tasks from the pending task pool is selected and scheduled for execution on the general processing cluster 1000. If an active task has been idle on the general processing cluster 1000, such as while waiting for a data dependency to be resolved, then the active task may be evicted from the general processing cluster 1000 and returned to the pending task pool while another task in the pending task pool is selected and scheduled for execution on the general processing cluster 1000.

The work distribution unit 916 communicates with the one or more general processing cluster 1000 modules via crossbar 908. The crossbar 908 is an interconnect network that couples many of the units of the parallel processing unit 902 to other units of the parallel processing unit 902. For example, the crossbar 908 may be configured to couple the work distribution unit 916 to a particular general processing cluster 1000. Although not shown explicitly, one or more other units of the parallel processing unit 902 may also be connected to the crossbar 908 via the hub 918.

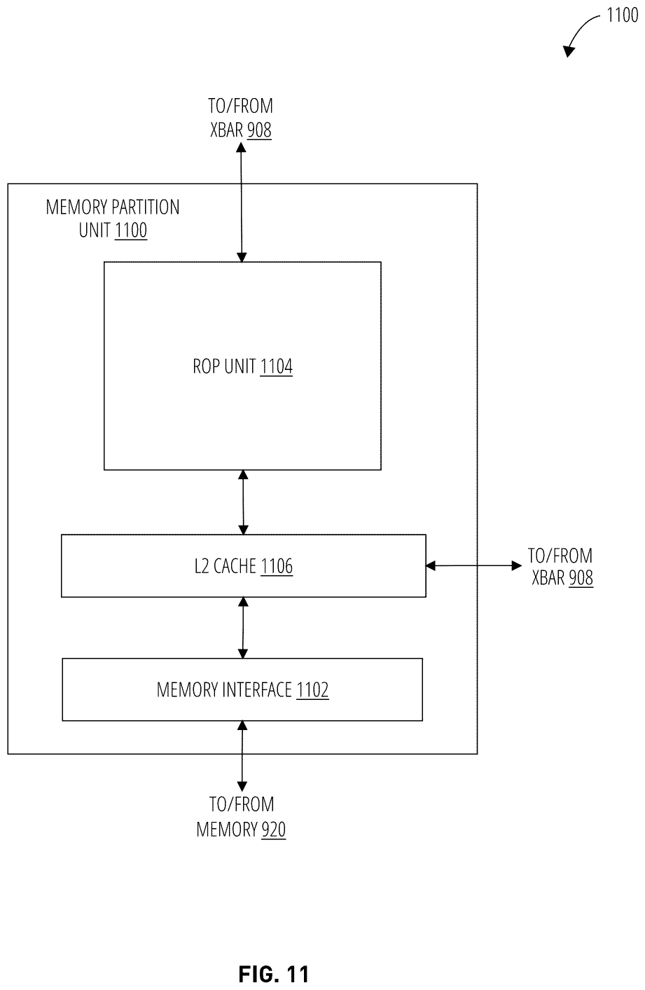

The tasks are managed by the scheduler unit 914 and dispatched to a general processing cluster 1000 by the work distribution unit 916. The general processing cluster 1000 is configured to process the task and generate results. The results may be consumed by other tasks within the general processing cluster 1000, routed to a different general processing cluster 1000 via the crossbar 908, or stored in the memory 920. The results can be written to the memory 920 via the memory partition unit 1100 modules, which implement a memory interface for reading and writing data to/from the memory 920. The results can be transmitted to another parallel processing unit 902 or CPU via the NVLink 904. In an embodiment, the parallel processing unit 902 includes a number U of memory partition unit 1100 modules that is equal to the number of separate and distinct memory 920 devices coupled to the parallel processing unit 902. A memory partition unit 1100 will be described in more detail below in conjunction with FIG. 11.

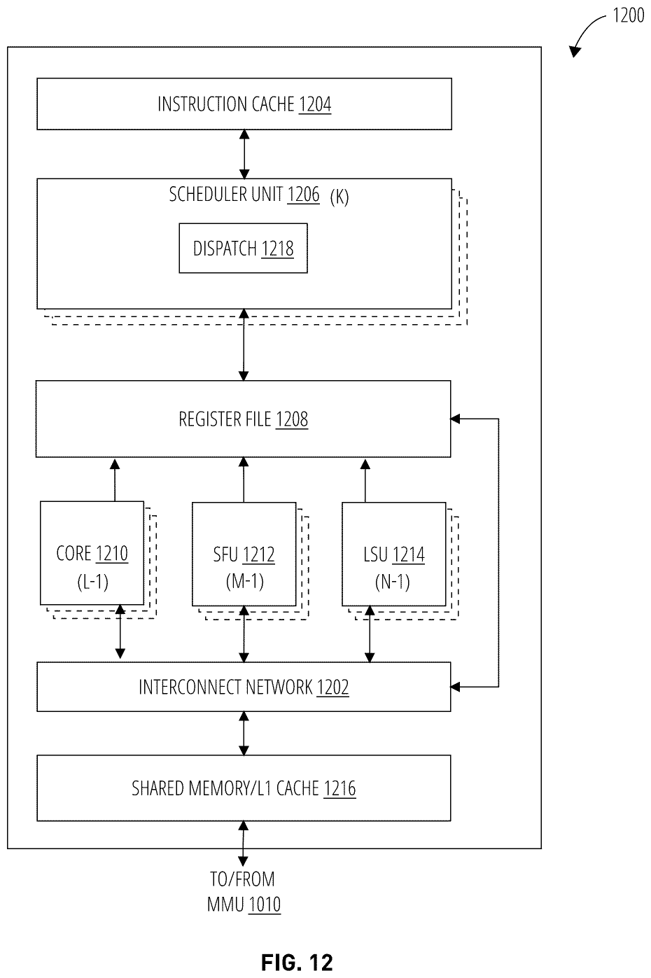

In an embodiment, a host processor executes a driver kernel that implements an application programming interface (API) that enables one or more applications executing on the host processor to schedule operations for execution on the parallel processing unit 902. In an embodiment, multiple compute applications are simultaneously executed by the parallel processing unit 902 and the parallel processing unit 902 provides isolation, quality of service (QoS), and independent address spaces for the multiple compute applications. An application may generate instructions (e.g., API calls) that cause the driver kernel to generate one or more tasks for execution by the parallel processing unit 902. The driver kernel outputs tasks to one or more streams being processed by the parallel processing unit 902. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 12.

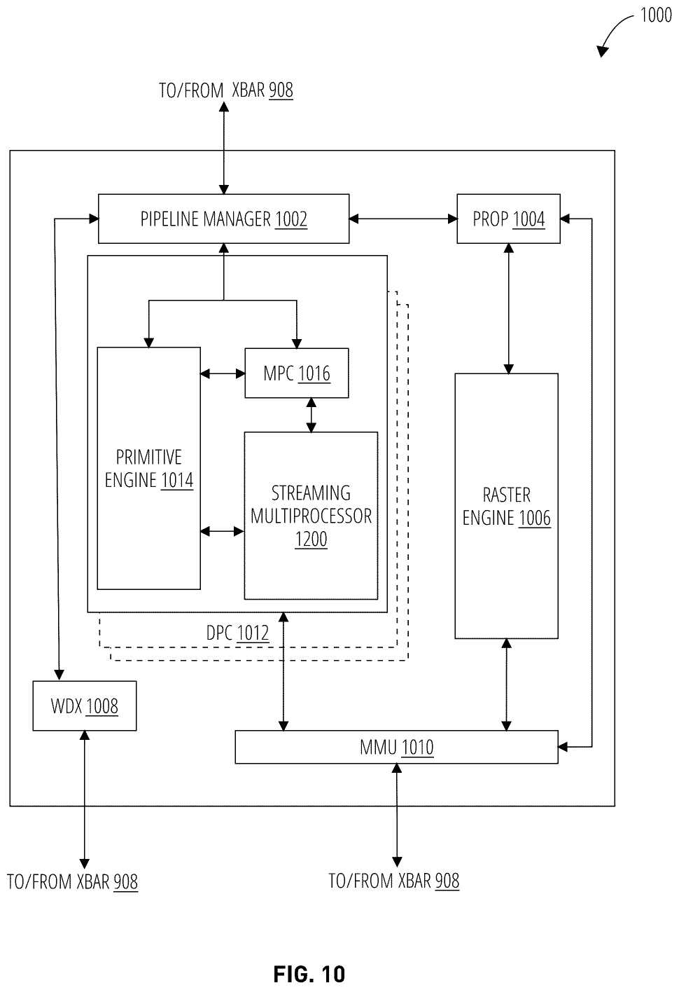

FIG. 10 depicts a general processing cluster 1000 of the parallel processing unit 902 of FIG. 9, in accordance with an embodiment. As shown in FIG. 10, each general processing cluster 1000 includes a number of hardware units for processing tasks. In an embodiment, each general processing cluster 1000 includes a pipeline manager 1002, a pre-raster operations unit 1004, a raster engine 1006, a work distribution crossbar 1008, a memory management unit 1010, and one or more data processing cluster 1012. It will be appreciated that the general processing cluster 1000 of FIG. 10 may include other hardware units in lieu of or in addition to the units shown in FIG. 10.

In an embodiment, the operation of the general processing cluster 1000 is controlled by the pipeline manager 1002. The pipeline manager 1002 manages the configuration of the one or more data processing cluster 1012 modules for processing tasks allocated to the general processing cluster 1000. In an embodiment, the pipeline manager 1002 may configure at least one of the one or more data processing cluster 1012 modules to implement at least a portion of a graphics rendering pipeline. For example, a data processing cluster 1012 may be configured to execute a vertex shader program on the programmable streaming multiprocessor 1200. The pipeline manager 1002 may also be configured to route packets received from the work distribution unit 916 to the appropriate logical units within the general processing cluster 1000. For example, some packets may be routed to fixed function hardware units in the pre-raster operations unit 1004 and/or raster engine 1006 while other packets may be routed to the data processing cluster 1012 modules for processing by the primitive engine 1014 or the streaming multiprocessor 1200. In an embodiment, the pipeline manager 1002 may configure at least one of the one or more data processing cluster 1012 modules to implement a neural network model and/or a computing pipeline.

The pre-raster operations unit 1004 is configured to route data generated by the raster engine 1006 and the data processing cluster 1012 modules to a Raster Operations (ROP) unit, described in more detail in conjunction with FIG. 11. The pre-raster operations unit 1004 may also be configured to perform optimizations for color blending, organize pixel data, perform address translations, and the like.

The raster engine 1006 includes a number of fixed function hardware units configured to perform various raster operations. In an embodiment, the raster engine 1006 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1006 comprises fragments to be processed, for example, by a fragment shader implemented within a data processing cluster 1012.

Each data processing cluster 1012 included in the general processing cluster 1000 includes an M-pipe controller 1016, a primitive engine 1014, and one or more streaming multiprocessor 1200 modules. The M-pipe controller 1016 controls the operation of the data processing cluster 1012, routing packets received from the pipeline manager 1002 to the appropriate units in the data processing cluster 1012. For example, packets associated with a vertex may be routed to the primitive engine 1014, which is configured to fetch vertex attributes associated with the vertex from the memory 920. In contrast, packets associated with a shader program may be transmitted to the streaming multiprocessor 1200.

The streaming multiprocessor 1200 comprises a programmable streaming processor that is configured to process tasks represented by a number of threads. Each streaming multiprocessor 1200 is multi-threaded and configured to execute a plurality of threads (e.g., 32 threads) from a particular group of threads concurrently. In an embodiment, the streaming multiprocessor 1200 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1200 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1200 will be described in more detail below in conjunction with FIG. 12.

The memory management unit 1010 provides an interface between the general processing cluster 1000 and the memory partition unit 1100. The memory management unit 1010 may provide translation of virtual addresses into physical addresses, memory protection, and arbitration of memory requests. In an embodiment, the memory management unit 1010 provides one or more translation lookaside buffers (TLBs) for performing translation of virtual addresses into physical addresses in the memory 920.

FIG. 11 depicts a memory partition unit 1100 of the parallel processing unit 902 of FIG. 9, in accordance with an embodiment. As shown in FIG. 11, the memory partition unit 1100 includes a raster operations unit 1104, a level two cache 1106, and a memory interface 1102. The memory interface 1102 is coupled to the memory 920. Memory interface 1102 may implement 32, 64, 128, 1024-bit data buses, or the like, for high-speed data transfer. In an embodiment, the parallel processing unit 902 incorporates U memory interface 1102 modules, one memory interface 1102 per pair of memory partition unit 1100 modules, where each pair of memory partition unit 1100 modules is connected to a corresponding memory 920 device. For example, parallel processing unit 902 may be connected to up to Y memory 920 devices, such as high bandwidth memory stacks or graphics double-data-rate, version 5, synchronous dynamic random access memory, or other types of persistent storage.

In an embodiment, the memory interface 1102 implements an HBM2 memory interface and Y equals half U. In an embodiment, the HBM2 memory stacks are located on the same physical package as the parallel processing unit 902, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 920 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 902 modules process very large datasets and/or run applications for extended periods.

In an embodiment, the parallel processing unit 902 implements a multi-level memory hierarchy. In an embodiment, the memory partition unit 1100 supports a unified memory to provide a single unified virtual address space for CPU and parallel processing unit 902 memory, enabling data sharing between virtual memory systems. In an embodiment the frequency of accesses by a parallel processing unit 902 to memory located on other processors is traced to ensure that memory pages are moved to the physical memory of the parallel processing unit 902 that is accessing the pages more frequently. In an embodiment, the NVLink 904 supports address translation services allowing the parallel processing unit 902 to directly access a CPU's page tables and providing full access to CPU memory by the parallel processing unit 902.

In an embodiment, copy engines transfer data between multiple parallel processing unit 902 modules or between parallel processing unit 902 modules and CPUs. The copy engines can generate page faults for addresses that are not mapped into the page tables. The memory partition unit 1100 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 920 or other system memory may be fetched by the memory partition unit 1100 and stored in the level two cache 1106, which is located on-chip and is shared between the various general processing cluster 1000 modules. As shown, each memory partition unit 1100 includes a portion of the level two cache 1106 associated with a corresponding memory 920 device. Lower level caches may then be implemented in various units within the general processing cluster 1000 modules. For example, each of the streaming multiprocessor 1200 modules may implement an L1 cache. The L1 cache is private memory that is dedicated to a particular streaming multiprocessor 1200. Data from the level two cache 1106 may be fetched and stored in each of the L1 caches for processing in the functional units of the streaming multiprocessor 1200 modules. The level two cache 1106 is coupled to the memory interface 1102 and the crossbar 908.

The raster operations unit 1104 performs graphics raster operations related to pixel color, such as color compression, pixel blending, and the like. The raster operations unit 1104 also implements depth testing in conjunction with the raster engine 1006, receiving a depth for a sample location associated with a pixel fragment from the culling engine of the raster engine 1006. The depth is tested against a corresponding depth in a depth buffer for a sample location associated with the fragment. If the fragment passes the depth test for the sample location, then the raster operations unit 1104 updates the depth buffer and transmits a result of the depth test to the raster engine 1006. It will be appreciated that the number of partition memory partition unit 1100 modules may be different than the number of general processing cluster 1000 modules and, therefore, each raster operations unit 1104 may be coupled to each of the general processing cluster 1000 modules. The raster operations unit 1104 tracks packets received from the different general processing cluster 1000 modules and determines which general processing cluster 1000 that a result generated by the raster operations unit 1104 is routed to through the crossbar 908. Although the raster operations unit 1104 is included within the memory partition unit 1100 in FIG. 11, in other embodiment, the raster operations unit 1104 may be outside of the memory partition unit 1100. For example, the raster operations unit 1104 may reside in the general processing cluster 1000 or another unit.

FIG. 12 illustrates the streaming multiprocessor 1200 of FIG. 10, in accordance with an embodiment. As shown in FIG. 12, the streaming multiprocessor 1200 includes an instruction cache 1204, one or more scheduler unit 1206 modules (e.g., such as scheduler unit 914), a register file 1208, one or more processing core 1210 modules, one or more special function unit 1212 modules, one or more load/store unit 1214 modules, an interconnect network 1202, and a shared memory/L1 cache 1216.

As described above, the work distribution unit 916 dispatches tasks for execution on the general processing cluster 1000 modules of the parallel processing unit 902. The tasks are allocated to a particular data processing cluster 1012 within a general processing cluster 1000 and, if the task is associated with a shader program, the task may be allocated to a streaming multiprocessor 1200. The scheduler unit 914 receives the tasks from the work distribution unit 916 and manages instruction scheduling for one or more thread blocks assigned to the streaming multiprocessor 1200. The scheduler unit 1206 schedules thread blocks for execution as warps of parallel threads, where each thread block is allocated at least one warp. In an embodiment, each warp executes 32 threads. The scheduler unit 1206 may manage a plurality of different thread blocks, allocating the warps to the different thread blocks and then dispatching instructions from the plurality of different cooperative groups to the various functional units (e.g., core 1210 modules, special function unit 1212 modules, and load/store unit 1214 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1218 unit is configured within the scheduler unit 1206 to transmit instructions to one or more of the functional units. In one embodiment, the scheduler unit 1206 includes two dispatch 1218 units that enable two different instructions from the same warp to be dispatched during each clock cycle. In alternative embodiments, each scheduler unit 1206 may include a single dispatch 1218 unit or additional dispatch 1218 units.

Each streaming multiprocessor 1200 includes a register file 1208 that provides a set of registers for the functional units of the streaming multiprocessor 1200. In an embodiment, the register file 1208 is divided between each of the functional units such that each functional unit is allocated a dedicated portion of the register file 1208. In another embodiment, the register file 1208 is divided between the different warps being executed by the streaming multiprocessor 1200. The register file 1208 provides temporary storage for operands connected to the data paths of the functional units.

Each streaming multiprocessor 1200 comprises L processing core 1210 modules. In an embodiment, the streaming multiprocessor 1200 includes a large number (e.g., 128, etc.) of distinct processing core 1210 modules. Each core 1210 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1210 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1210 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1200 also comprises M special function unit 1212 modules that perform special functions (e.g., attribute evaluation, reciprocal square root, and the like). In an embodiment, the special function unit 1212 modules may include a tree traversal unit configured to traverse a hierarchical tree data structure. In an embodiment, the special function unit 1212 modules may include texture unit configured to perform texture map filtering operations. In an embodiment, the texture units are configured to load texture maps (e.g., a 2D array of texels) from the memory 920 and sample the texture maps to produce sampled texture values for use in shader programs executed by the streaming multiprocessor 1200. In an embodiment, the texture maps are stored in the shared memory/L1 cache 1216. The texture units implement texture operations such as filtering operations using mip-maps (e.g., texture maps of varying levels of detail). In an embodiment, each streaming multiprocessor 1200 includes two texture units.

Each streaming multiprocessor 1200 also comprises N load/store unit 1214 modules that implement load and store operations between the shared memory/L1 cache 1216 and the register file 1208. Each streaming multiprocessor 1200 includes an interconnect network 1202 that connects each of the functional units to the register file 1208 and the load/store unit 1214 to the register file 1208 and shared memory/L1 cache 1216. In an embodiment, the interconnect network 1202 is a crossbar that can be configured to connect any of the functional units to any of the registers in the register file 1208 and connect the load/store unit 1214 modules to the register file 1208 and memory locations in shared memory/L1 cache 1216.

The shared memory/L1 cache 1216 is an array of on-chip memory that allows for data storage and communication between the streaming multiprocessor 1200 and the primitive engine 1014 and between threads in the streaming multiprocessor 1200. In an embodiment, the shared memory/L1 cache 1216 comprises 128 KB of storage capacity and is in the path from the streaming multiprocessor 1200 to the memory partition unit 1100. The shared memory/L1 cache 1216 can be used to cache reads and writes. One or more of the shared memory/L1 cache 1216, level two cache 1106, and memory 920 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1216 enables the shared memory/L1 cache 1216 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 9, are bypassed, creating a much simpler programming model. In the general purpose parallel computation configuration, the work distribution unit 916 assigns and distributes blocks of threads directly to the data processing cluster 1012 modules. The threads in a block execute the same program, using a unique thread ID in the calculation to ensure each thread generates unique results, using the streaming multiprocessor 1200 to execute the program and perform calculations, shared memory/L1 cache 1216 to communicate between threads, and the load/store unit 1214 to read and write global memory through the shared memory/L1 cache 1216 and the memory partition unit 1100. When configured for general purpose parallel computation, the streaming multiprocessor 1200 can also write commands that the scheduler unit 914 can use to launch new work on the data processing cluster 1012 modules.

The parallel processing unit 902 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 902 is embodied on a single semiconductor substrate. In another embodiment, the parallel processing unit 902 is included in a system-on-a-chip (SoC) along with one or more other devices such as additional parallel processing unit 902 modules, the memory 920, a reduced instruction set computer (RISC) CPU, a memory management unit (MMU), a digital-to-analog converter (DAC), and the like.

In an embodiment, the parallel processing unit 902 may be included on a graphics card that includes one or more memory devices. The graphics card may be configured to interface with a PCIe slot on a motherboard of a desktop computer. In yet another embodiment, the parallel processing unit 902 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13 is a conceptual diagram of a processing system 1300 implemented using the parallel processing unit 902 of FIG. 9, in accordance with an embodiment. The processing system 1300 includes a central processing unit 1304, switch 1302, and multiple parallel processing unit 902 modules each and respective memory 920 modules. The NVLink 904 provides high-speed communication links between each of the parallel processing unit 902 modules. Although a particular number of NVLink 904 and interconnect 906 connections are illustrated in FIG. 13, the number of connections to each parallel processing unit 902 and the central processing unit 1304 may vary. The switch 1302 interfaces between the interconnect 906 and the central processing unit 1304. The parallel processing unit 902 modules, memory 920 modules, and NVLink 904 connections may be situated on a single semiconductor platform to form a parallel processing module 1306. In an embodiment, the switch 1302 supports two or more protocols to interface between various different connections and/or links.

In another embodiment (not shown), the NVLink 904 provides one or more high-speed communication links between each of the parallel processing unit modules (parallel processing unit 902, parallel processing unit 902, parallel processing unit 902, and parallel processing unit 902) and the central processing unit 1304 and the switch 1302 interfaces between the interconnect 906 and each of the parallel processing unit modules. The parallel processing unit modules, memory 920 modules, and interconnect 906 may be situated on a single semiconductor platform to form a parallel processing module 1306. In yet another embodiment (not shown), the interconnect 906 provides one or more communication links between each of the parallel processing unit modules and the central processing unit 1304 and the switch 1302 interfaces between each of the parallel processing unit modules using the NVLink 904 to provide one or more high-speed communication links between the parallel processing unit modules. In another embodiment (not shown), the NVLink 904 provides one or more high-speed communication links between the parallel processing unit modules and the central processing unit 1304 through the switch 1302. In yet another embodiment (not shown), the interconnect 906 provides one or more communication links between each of the parallel processing unit modules directly. One or more of the NVLink 904 high-speed communication links may be implemented as a physical NVLink interconnect or either an on-chip or on-die interconnect using the same protocol as the NVLink 904.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1306 may be implemented as a circuit board substrate and each of the parallel processing unit modules and/or memory 920 modules may be packaged devices. In an embodiment, the central processing unit 1304, switch 1302, and the parallel processing module 1306 are situated on a single semiconductor platform.

In an embodiment, the signaling rate of each NVLink 904 is 20 to 25 Gigabits/second and each parallel processing unit module includes six NVLink 904 interfaces (as shown in FIG. 13, five NVLink 904 interfaces are included for each parallel processing unit module). Each NVLink 904 provides a data transfer rate of 25 Gigabytes/second in each direction, with six links providing 300 Gigabytes/second. The NVLink 904 can be used exclusively for PPU-to-PPU communication as shown in FIG. 13, or some combination of PPU-to-PPU and PPU-to-CPU, when the central processing unit 1304 also includes one or more NVLink 904 interfaces.

In an embodiment, the NVLink 904 allows direct load/store/atomic access from the central processing unit 1304 to each parallel processing unit module's memory 920. In an embodiment, the NVLink 904 supports coherency operations, allowing data read from the memory 920 modules to be stored in the cache hierarchy of the central processing unit 1304, reducing cache access latency for the central processing unit 1304. In an embodiment, the NVLink 904 includes support for Address Translation Services (ATS), enabling the parallel processing unit module to directly access page tables within the central processing unit 1304. One or more of the NVLink 904 may also be configured to operate in a low-power mode.

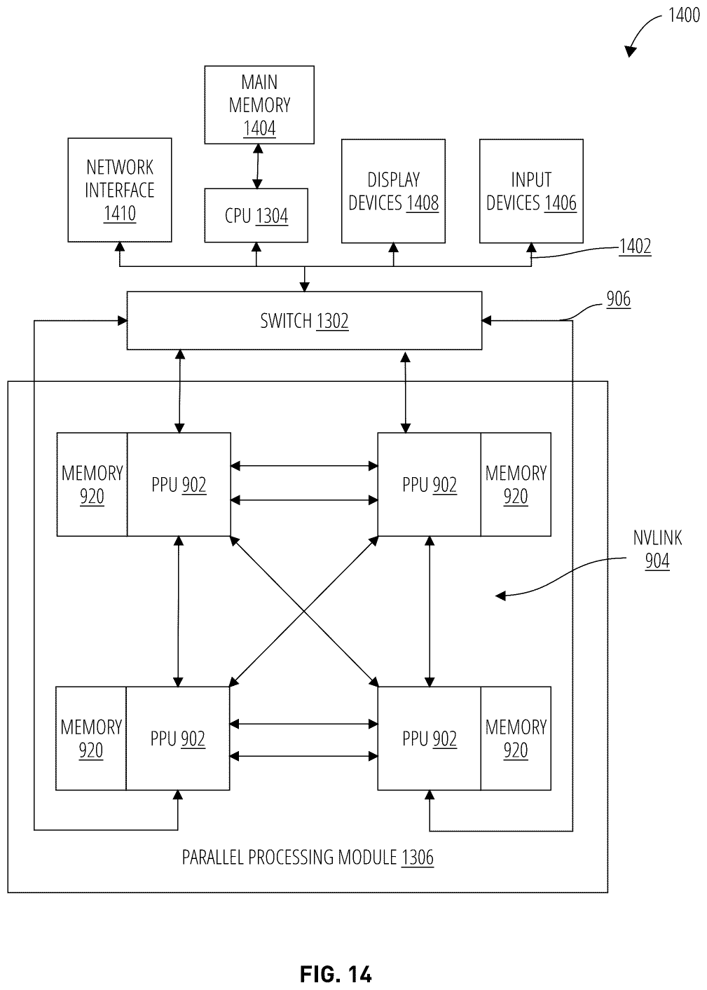

FIG. 14 depicts an exemplary processing system 1400 in which the various architecture and/or functionality of the various previous embodiments may be implemented. As shown, an exemplary processing system 1400 is provided including at least one central processing unit 1304 that is connected to a communications bus 1402. The communication communications bus 1402 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1400 also includes a main memory 1404. Control logic (software) and data are stored in the main memory 1404 which may take the form of random access memory (RAM).

The exemplary processing system 1400 also includes input devices 1406, the parallel processing module 1306, and display devices 1408, e.g. a conventional CRT (cathode ray tube), LCD (liquid crystal display), LED (light emitting diode), plasma display or the like. User input may be received from the input devices 1406, e.g., keyboard, mouse, touchpad, microphone, and the like. Each of the foregoing modules and/or devices may even be situated on a single semiconductor platform to form the exemplary processing system 1400. Alternately, the various modules may also be situated separately or in various combinations of semiconductor platforms per the desires of the user.

Further, the exemplary processing system 1400 may be coupled to a network (e.g., a telecommunications network, local area network (LAN), wireless network, wide area network (WAN) such as the Internet, peer-to-peer network, cable network, or the like) through a network interface 1410 for communication purposes.

The exemplary processing system 1400 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1404 and/or the secondary storage. Such computer programs, when executed, enable the exemplary processing system 1400 to perform various functions. The main memory 1404, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1400 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

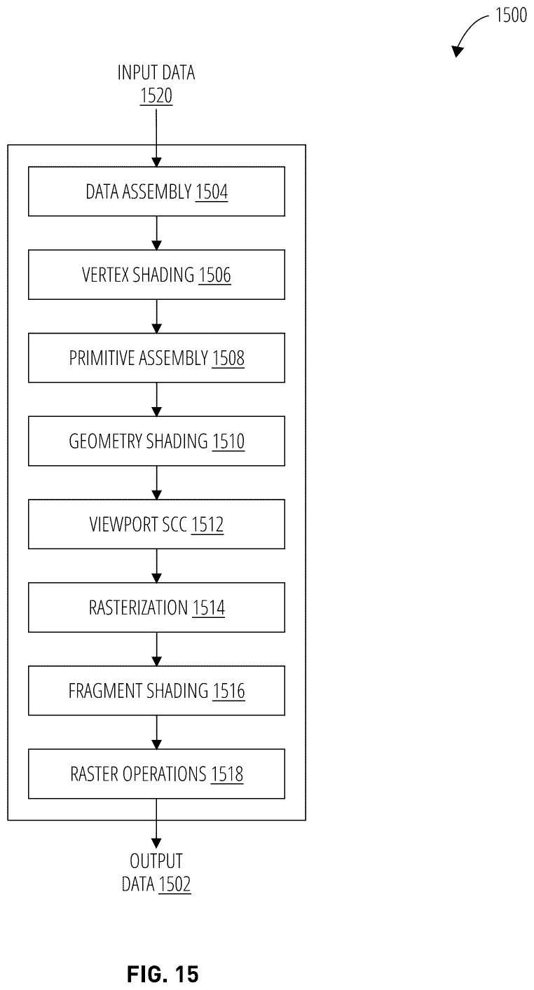

FIG. 15 is a conceptual diagram of a graphics processing pipeline 1500 implemented by the parallel processing unit 902 of FIG. 9, in accordance with an embodiment. In an embodiment, the parallel processing unit 902 comprises a graphics processing unit (GPU). The parallel processing unit 902 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 902 can be configured to process the graphics primitives to generate a frame buffer (e.g., pixel data for each of the pixels of the display).

An application writes model data for a scene (e.g., a collection of vertices and attributes) to a memory such as a system memory or memory 920. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 1200 modules of the parallel processing unit 902 including one or more of a vertex shader, hull shader, domain shader, geometry shader, and a pixel shader. For example, one or more of the streaming multiprocessor 1200 modules may be configured to execute a vertex shader program that processes a number of vertices defined by the model data. In an embodiment, the different streaming multiprocessor 1200 modules may be configured to execute different shader programs concurrently. For example, a first subset of streaming multiprocessor 1200 modules may be configured to execute a vertex shader program while a second subset of streaming multiprocessor 1200 modules may be configured to execute a pixel shader program. The first subset of streaming multiprocessor 1200 modules processes vertex data to produce processed vertex data and writes the processed vertex data to the level two cache 1106 and/or the memory 920. After the processed vertex data is rasterized (e.g., transformed from three-dimensional data into two-dimensional data in screen space) to produce fragment data, the second subset of streaming multiprocessor 1200 modules executes a pixel shader to produce processed fragment data, which is then blended with other processed fragment data and written to the frame buffer in memory 920. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 1500 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1500 receives input data 601 that is transmitted from one stage to the next stage of the graphics processing pipeline 1500 to generate output data 1502. In an embodiment, the graphics processing pipeline 1500 may represent a graphics processing pipeline defined by the OpenGL® API. As an option, the graphics processing pipeline 1500 may be implemented in the context of the functionality and architecture of the previous Figures and/or any subsequent Figure(s).

As shown in FIG. 15, the graphics processing pipeline 1500 comprises a pipeline architecture that includes a number of stages. The stages include, but are not limited to, a data assembly 1504 stage, a vertex shading 1506 stage, a primitive assembly 1508 stage, a geometry shading 1510 stage, a viewport SCC 1512 stage, a rasterization 1514 stage, a fragment shading 1516 stage, and a raster operations 1518 stage. In an embodiment, the input data 1520 comprises commands that configure the processing units to implement the stages of the graphics processing pipeline 1500 and geometric primitives (e.g., points, lines, triangles, quads, triangle strips or fans, etc.) to be processed by the stages. The output data 1502 may comprise pixel data (e.g., color data) that is copied into a frame buffer or other type of surface data structure in a memory.

The data assembly 1504 stage receives the input data 1520 that specifies vertex data for high-order surfaces, primitives, or the like. The data assembly 1504 stage collects the vertex data in a temporary storage or queue, such as by receiving a command from the host processor that includes a pointer to a buffer in memory and reading the vertex data from the buffer. The vertex data is then transmitted to the vertex shading 1506 stage for processing.

The vertex shading 1506 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1506 stage may manipulate individual vertex attributes such as position, color, texture coordinates, and the like. In other words, the vertex shading 1506 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1506 stage generates transformed vertex data that is transmitted to the primitive assembly 1508 stage.

The primitive assembly 1508 stage collects vertices output by the vertex shading 1506 stage and groups the vertices into geometric primitives for processing by the geometry shading 1510 stage. For example, the primitive assembly 1508 stage may be configured to group every three consecutive vertices as a geometric primitive (e.g., a triangle) for transmission to the geometry shading 1510 stage. In some embodiments, specific vertices may be reused for consecutive geometric primitives (e.g., two consecutive triangles in a triangle strip may share two vertices). The primitive assembly 1508 stage transmits geometric primitives (e.g., a collection of associated vertices) to the geometry shading 1510 stage.

The geometry shading 1510 stage processes geometric primitives by performing a set of operations (e.g., a geometry shader or program) on the geometric primitives. Tessellation operations may generate one or more geometric primitives from each geometric primitive. In other words, the geometry shading 1510 stage may subdivide each geometric primitive into a finer mesh of two or more geometric primitives for processing by the rest of the graphics processing pipeline 1500. The geometry shading 1510 stage transmits geometric primitives to the viewport SCC 1512 stage.

In an embodiment, the graphics processing pipeline 1500 may operate within a streaming multiprocessor and the vertex shading 1506 stage, the primitive assembly 1508 stage, the geometry shading 1510 stage, the fragment shading 1516 stage, and/or hardware/software associated therewith, may sequentially perform processing operations. Once the sequential processing operations are complete, in an embodiment, the viewport SCC 1512 stage may utilize the data. In an embodiment, primitive data processed by one or more of the stages in the graphics processing pipeline 1500 may be written to a cache (e.g. L1 cache, a vertex cache, etc.). In this case, in an embodiment, the viewport SCC 1512 stage may access the data in the cache. In an embodiment, the viewport SCC 1512 stage and the rasterization 1514 stage are implemented as fixed function circuitry.

The viewport SCC 1512 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1514 stage.

The rasterization 1514 stage converts the 3D geometric primitives into 2D fragments (e.g. capable of being utilized for display, etc.). The rasterization 1514 stage may be configured to utilize the vertices of the geometric primitives to setup a set of plane equations from which various attributes can be interpolated. The rasterization 1514 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1514 stage generates fragment data (e.g., interpolated vertex attributes associated with a particular sample location for each covered pixel) that are transmitted to the fragment shading 1516 stage.

The fragment shading 1516 stage processes fragment data by performing a set of operations (e.g., a fragment shader or a program) on each of the fragments. The fragment shading 1516 stage may generate pixel data (e.g., color values) for the fragment such as by performing lighting operations or sampling texture maps using interpolated texture coordinates for the fragment. The fragment shading 1516 stage generates pixel data that is transmitted to the raster operations 1518 stage.

The raster operations 1518 stage may perform various operations on the pixel data such as performing alpha tests, stencil tests, and blending the pixel data with other pixel data corresponding to other fragments associated with the pixel. When the raster operations 1518 stage has finished processing the pixel data (e.g., the output data 1502), the pixel data may be written to a render target such as a frame buffer, a color buffer, or the like.

It will be appreciated that one or more additional stages may be included in the graphics processing pipeline 1500 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1510 stage). Other types of graphics processing pipelines are contemplated as being within the scope of the present disclosure. Furthermore, any of the stages of the graphics processing pipeline 1500 may be implemented by one or more dedicated hardware units within a graphics processor such as parallel processing unit 902. Other stages of the graphics processing pipeline 1500 may be implemented by programmable hardware units such as the streaming multiprocessor 1200 of the parallel processing unit 902.

The graphics processing pipeline 1500 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 902. The API provides an abstraction for a programmer that lets a programmer utilize specialized graphics hardware, such as the parallel processing unit 902, to generate the graphical data without requiring the programmer to utilize the specific instruction set for the parallel processing unit 902. The application may include an API call that is routed to the device driver for the parallel processing unit 902. The device driver interprets the API call and performs various operations to respond to the API call. In some instances, the device driver may perform operations by executing instructions on the CPU. In other instances, the device driver may perform operations, at least in part, by launching operations on the parallel processing unit 902 utilizing an input/output interface between the CPU and the parallel processing unit 902. In an embodiment, the device driver is configured to implement the graphics processing pipeline 1500 utilizing the hardware of the parallel processing unit 902.

Various programs may be executed within the parallel processing unit 902 in order to implement the various stages of the graphics processing pipeline 1500. For example, the device driver may launch a kernel on the parallel processing unit 902 to perform the vertex shading 1506 stage on one streaming multiprocessor 1200 (or multiple streaming multiprocessor 1200 modules). The device driver (or the initial kernel executed by the parallel processing unit 902) may also launch other kernels on the parallel processing unit 902 to perform other stages of the graphics processing pipeline 1500, such as the geometry shading 1510 stage and the fragment shading 1516 stage. In addition, some of the stages of the graphics processing pipeline 1500 may be implemented on fixed unit hardware such as a rasterizer or a data assembler implemented within the parallel processing unit 902. It will be appreciated that results from one kernel may be processed by one or more intervening fixed function hardware units before being processed by a subsequent kernel on a streaming multiprocessor 1200.

### LISTING OF DRAWING ELEMENTS

102 processor
104 memory
106 port
108 encoder
110 decoder
112 port
114 memory
116 network fabric
118 processor
120 block
122 block
124 block
126 block
128 block
130 block
132 block
134 block
202 encoder
204 encoder
206 pruner
208 pruner
210 compression mode selector
212 scoring logic
214 iterative encoder
700 neural network processor
702 processing elements
704 global buffer
706 controller
708 network-on-a-package router
800 processing element
802 vector multiply-accumulate units
804 activation buffer
806 router
808 controller
810 accumulation memory buffer
812 weight buffer
814 post-processor
902 parallel processing unit
904 NVLink
906 interconnect
908 crossbar
910 I/O unit
912 front-end unit
914 scheduler unit
916 work distribution unit
918 hub
920 memory
1000 general processing cluster
1002 pipeline manager
1004 pre-raster operations unit
1006 raster engine
1008 work distribution crossbar
1010 memory management unit
1012 data processing cluster
1014 primitive engine
1016 M-pipe controller
1100 memory partition unit
1102 memory interface
1104 raster operations unit
1106 level two cache
1200 streaming multiprocessor
1202 interconnect network
1204 instruction cache
1206 scheduler unit
1208 register file
1210 core
1212 special function unit
1214 load/store unit
1216 shared memory/L1 cache
1218 dispatch
1300 processing system
1302 switch
1304 central processing unit
1306 parallel processing module
1400 exemplary processing system
1402 communications bus
1404 main memory
1406 input devices
1408 display devices
1410 network interface
1500 graphics processing pipeline
1502 output data
1504 data assembly
1506 vertex shading
1508 primitive assembly
1510 geometry shading
1512 viewport SCC
1514 rasterization
1516 fragment shading
1518 raster operations
1520 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A data network comprising:
an ingress port;
a plurality of per-vector scaled quantization encoders;
logic to:
in response to receiving a packet at the ingress port:
operate the plurality of per-vector scaled quantization encoders on the packet to generate a plurality of reduced vectors;
score each of the reduced vectors according to a precision loss; and
select one of the reduced vectors to inject into the network based on the score.

2. The data network of claim 1, wherein the per-vector scaled quantization encoders are operated on the packet in parallel.

3. The data network of claim 2, wherein at least one of the per-vector scaled quantization encoders implements a 4-bit floating point per-vector scaled quantization.

4. The data network of claim 2, wherein at least one of the per-vector scaled quantization encoders implements an 8-bit floating point per-vector scaled quantization.

5. The data network of claim 1, further comprising:
at least one induced sparsity encoder of type n:m, where m is a group size and n<m is a number of values to retain or drop from the group of m.

6. The data network of claim 5, wherein the induced sparsity encoder is configured to operate in parallel with the plurality of per-vector scaled quantization encoders.

7. The data network of claim 5, further comprising logic to combine operation of at least one of the per-vector scaled quantization encoders with operation of the at least one induced sparsity encoder.

8. The data network of claim 7, wherein the at least one of the per-vector scaled quantization encoders and the at least one induced sparsity encoder are operated sequentially on the vector.

9. A system comprising:
a first processor;
a first memory;
a communication link comprising a first port; and
logic to:
in response to transferring a vector of values from the first memory to the first port by the first processor:
apply a plurality of reduction mechanisms to the vector to generate a plurality of reduced vectors;
score each of the reduced vectors according to configured precision and compression settings; and
select one of the reduced vectors to ingress the network based on the score.

10. The system of claim 9, wherein at least one of the reduction mechanisms is a per-vector scaled quantization.

11. The system of claim 9, wherein a plurality of the reduction mechanisms are different types of per-vector scaled quantization.

12. The system of claim 11, wherein at least one of the reduction mechanisms is a 4-bit floating point per-vector scaled quantization.

13. The system of claim 11, wherein at least one of the reduction mechanisms is an 8-bit floating point per-vector scaled quantization.

14. The system of claim 9, wherein at least one of the reduction mechanisms is an induced sparsity of type n:m, where m is a group size and n<m is a number of values to retain or drop from the group of m.

15. The system of claim 9, wherein a plurality of the reduction mechanisms are different types of induced sparsity.

16. The system of claim 15, wherein the different types of induced sparsity mechanisms are applied to the vector sequentially.

17. The system of claim 9, wherein at least one of the reduction mechanisms comprises a combination of per-vector scaled quantization and induced sparsity.

18. The system of claim 9, further comprising:
a second processor;
a second memory;
a second port coupled to the communication link; and
logic to:
expand the select one of the reduced vectors in response to receiving the selected one of the reduced vectors at the second port;
write the expanded vector to the second memory; and
read the expanded vector from the second memory with the second processor.

19. The system of claim 18, wherein the first port, the second port, and the communication link are comprised by a network switch or router.

20. A data communication process comprising:
in response to receiving a packet at an ingress port to a data network or router:
applying a plurality of reduction mechanisms to the packet to generate a plurality of reduced packets;
determining in parallel a precision loss metric for each of the reduced packets; and
selecting a one of the reduced packets with a lowest precision loss to ingress the network or router based on the metric.
